(19) United States
(12) Patent Application Publication
(10) Pub. No.: US 2021/0335315 A1
(43) Pub. Date: Oct. 28, 2021

(54) SOURCE DRIVING ENHANCEMENT CIRCUIT, SOURCE DRIVING ENHANCEMENT METHOD, SOURCE DRIVING CIRCUIT, AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Yuan ZHANG, Beijing (CN); Lei LIU, Beijing (CN)

(21) Appl. No.: 16/327,783

(22) PCT Filed: May 11, 2018
(86) PCT No.: PCT/CN2018/086523

§ 371 Date: Feb. 22, 2019

(30) Foreign Application Priority Data
Aug. 22, 2017 (CN) 2017107268946

(51) Int. Cl. G09G 3/36

(52) U.S. Cl. CPC G09G 3/3696; G09G 3/3688; G09G 2300/0842; G09G 2320/0223; G09G 2330/023; G09G 2310/0248

(57) ABSTRACT

The present disclosure provides a source driving enhancement circuit. The source driving enhancement circuit includes a switch sub-circuit, a charging sub-circuit, an enhancement sub-circuit, and an energy storage sub-circuit. The switch sub-circuit is electrically connected to a switch control signal line, a source driving signal line, and a data line. The charging sub-circuit is electrically connected to a charging control signal line, and a first terminal and a second terminal of the energy storage sub-circuit, and is configured to receive a first voltage and a charging voltage under control of the charging control signal, and charge the energy storage sub-circuit using the first voltage and the charging voltage. The enhancement sub-circuit is electrically connected to an enhancement control signal line, the source driving signal line, the data line, and the first terminal and the second terminal of the energy storage sub-circuit.

### CROSS-REFERENCE TO RELATED APPLICATION(S)

This application is the National Phase of PCT Application No. PCT/CN2018/086523, filed May 11, 2018, entitled “SOURCE DRIVING ENHANCEMENT CIRCUIT, SOURCE DRIVING ENHANCEMENT METHOD, SOURCE DRIVING CIRCUIT, AND DISPLAY DEVICE” which claims priority to the Chinese Patent Application No. 201710726894.6, filed on Aug. 22, 2017, which are incorporated herein by reference in their entireties.

### TECHNICAL FIELD

The present disclosure relates to the field of display driving, and more particularly, to a source driving enhancement circuit, a source driving enhancement method, a source driving circuit, and a display device.

### BACKGROUND

Currently, an output of a source driver is directly input to a display screen of a Thin Film Transistor-Liquid Crystal Display (TFT-LCD). However, due to many equivalent resistors and capacitors existing in the screen, a Resistance Capacitance (RC) delay is likely to occur at a far end of a position where a source Chip on Flex (COF) package is combined. This delay becomes more serious as the screen gets bigger and bigger. When the delay is large enough or when a refresh rate increases and thus a charging cycle needs to be shortened, a source data line may not be able to charge pixel units to a predetermined voltage before a gate driver is turned off.

### SUMMARY

The present disclosure proposes a source driving enhancement circuit, a source driving enhancement method, a source driving circuit, and a display device.

According to an aspect of the present disclosure, there is proposed a source driving enhancement circuit. The source driving enhancement circuit comprises: a switch sub-circuit, a charging sub-circuit, an enhancement sub-circuit and an energy storage sub-circuit. The switch sub-circuit is electrically connected to a switch control signal line, a source driving signal line, and a data line.

The charging sub-circuit is electrically connected to a charging control signal line, and the first terminal and the second terminal of the energy storage sub-circuit, and is configured to receive a first voltage, a charging voltage, and a charging control signal from the charging control signal line, and charge the energy storage sub-circuit using the first voltage and the charging voltage under control of the charging control signal.

The enhancement sub-circuit is electrically connected to an enhancement control signal line, the source driving signal line, the data line, and the first terminal and the second terminal of the energy storage sub-circuit, and is configured to receive an enhancement control signal from the enhancement control signal line, and provide an enhanced source driving signal to the data line under control of the enhancement control signal.

In one embodiment, the switch sub-circuit comprises a first transistor, wherein the first transistor has a gate connected to the charging control signal line, a first electrode connected to the source driving signal line, and a second electrode connected to the data line.

In one embodiment, the charging sub-circuit comprises a second transistor and a third transistor, wherein a gate of the second transistor and a gate of the third transistor are connected to the charging control signal line, the second transistor has a first electrode connected to receive the first voltage, and a second electrode connected to the first terminal of the energy storage sub-circuit, and the third transistor has a first electrode connected to receive the charging voltage, and a second electrode connected to the second terminal of the energy storage sub-circuit.

In one embodiment, the enhancement sub-circuit comprises a fourth transistor and a fifth transistor, wherein a gate of the fourth transistor and a gate of the fifth transistor are connected to the enhancement control signal line, the fourth transistor has a first electrode connected to the source driving signal line and a second electrode connected to the first terminal of the energy storage sub-circuit, and the fifth transistor has a first electrode connected to the data line, and a second electrode connected to the second terminal of the energy storage sub-circuit.

In one embodiment, the energy storage sub-circuit comprises a capacitor, wherein the first terminal and the second terminal of the energy storage sub-circuit are a first terminal and a second terminal of the capacitor respectively.

In one embodiment, in response not to enhancing the source driving signal, the switch sub-circuit is turned on, the charging sub-circuit is turned off, and the enhancement sub-circuit is turned off under control of the switch control signal, the charging control signal, and the enhancement control signal.

In one embodiment, in response to enhancing the source driving signal, under control of the switch control signal, the charging control signal, and the enhancement control signal, in a first period, the switch sub-circuit is turned on, the charging sub-circuit is turned on, and the enhancement sub-circuit is turned off, to charge the energy storage sub-circuit with the charging voltage, and in a second period, the switch sub-circuit is turned off, the charging sub-circuit is turned off, and the enhancement sub-circuit is turned on, to provide an enhanced source driving voltage to the data line, wherein the enhanced source driving voltage has an amplitude equal to a sum of an amplitude of the source driving voltage and an amplitude of the charging voltage minus the first voltage.

According to another aspect of the present disclosure, there is proposed a source driving enhancement method using the source driving enhancement circuit according to various embodiments described above. The source driving enhancement method comprises: determining whether the source driving is enhanced; when it is determined that the source driving signal is not enhanced, providing, on the switch control signal line, a switch control signal for turning on the switch sub-circuit, providing, on the charging control signal line, a charging control signal for turning off the charging sub-circuit, and providing, on the enhancement control signal line, an enhancement control signal for turning off the enhancement sub-circuit, to provide a source driving voltage to the data line, and when it is determined that the source driving signal is enhanced, during a first period, providing, on the switch control signal line, a switch control signal for turning on the switch sub-circuit, providing, on the charging control signal line, a charging control signal for turning on the charging sub-circuit, and providing, on the enhancement control signal line, an enhancement control signal for turning off the enhancement sub-circuit, to charge the energy storage sub-circuit with the charging voltage while providing the source driving voltage to the data line; and during a second period, providing, on the switch control signal line, a switch control signal for turning off the switch sub-circuit, providing, on the charging control signal line, a charging control signal for turning off the charging sub-circuit, and providing, on the enhancement control signal line, an enhancement control signal for turning on the enhancement sub-circuit, to provide an enhanced source driving voltage to the data line, wherein the enhanced source driving voltage has an amplitude equal to a sum of an amplitude of the source driving voltage and an amplitude of the charging voltage minus the first voltage.

According to yet another aspect of the present disclosure, there is proposed a source driving circuit. The source driving circuit comprises the source driving enhancement circuit according to various embodiments described above.

According to a further aspect of the present disclosure, there is proposed a display device. The display device comprises a switch control signal line, an enhancement control signal line, a data line, and the source driving circuit according to the embodiments of the present disclosure.

### BRIEF DESCRIPTION OF THE DRAWINGS

The above and other purposes, features and advantages of the present disclosure will become more apparent from the following description of the embodiments of the present disclosure with reference to the accompanying drawing, in which:

FIG. 1 illustrates a structural block diagram of a source driving enhancement circuit according to an embodiment of the present disclosure;

FIG. 2 illustrates a schematic circuit diagram of the source driving enhancement circuit shown in FIG. 1;

FIG. 3 illustrates a signal timing diagram of the circuit shown in FIG. 2; and

FIG. 4 illustrates a flowchart of a source driving enhancement method according to an embodiment of the present disclosure.

### DETAILED DESCRIPTION

Hereinafter, exemplary embodiments of the present disclosure will be described in detail with reference to the accompanying drawings. Throughout the accompanying drawings, the same elements are denoted by the same or similar reference numerals. In the following description, some specific embodiments are for illustrative purposes only and are not to be construed as limiting the present disclosure, but merely examples of the embodiments of the present disclosure. The conventional structure or construction will be omitted when it may cause confusion with the understanding of the present disclosure. It should be illustrated that shapes and sizes of various components in the figures do not reflect true sizes and proportions, but only illustrate contents of the embodiments of the present disclosure.

Throughout the specification, the reference to “one embodiment,” “an embodiment,” “one example” or “an example” means that the specific features, structures or properties described in conjunction with the embodiment or example are included in at least one embodiment of the present disclosure. Therefore, the phrases “in one embodiment,” “in an embodiment,” “in one example” or “in an example” occurred in various positions throughout the specification may not necessarily refer to the same embodiment or example. Furthermore, specific features, structures or properties may be combined into one or more embodiments or examples in any appropriate combination and/or sub-combination.

It should also be illustrated that those skilled in the art will appreciate that terms “A is connected with B” and “A is connected to B” may be that A is directly connected with B, or A is connected with B via one or more other components. In addition, “connected with” and “connected to” herein may be “physically electrically connected”, or may be “electrically coupled with” or “electrically coupled to” etc.

It will be appreciated by those skilled in the art that transistors used in all embodiments of the present disclosure may be thin film transistors or field effect transistors or other devices having the same characteristics. Preferably, the thin film transistors used in the embodiments of the present disclosure may be oxide semiconductor transistors. Further, as the source and the drain of the transistor used here are symmetrical, the source and the drain are interchangeable. In the following description, the term “first electrode” represents one of a source and a drain of a transistor, and the term “second electrode” represents the other of the source and the drain of the transistor.

In addition, the following embodiments are described by taking N-type transistors as an example, that is, when a gate voltage of a transistor is at a high level, the transistor is turned on, and when the gate voltage is at a low level, the transistor is turned off. It will be appreciated by those skilled in the art that P-type transistors may be used, that is, when a gate voltage of the transistor is at a low level, the transistor is turned on, and when the gate voltage is at a high level, the transistor is turned off. In this case, corresponding modifications of the circuit structure will be apparent to those skilled in the art.

The present disclosure will be described in detail below with reference to the accompanying drawings.

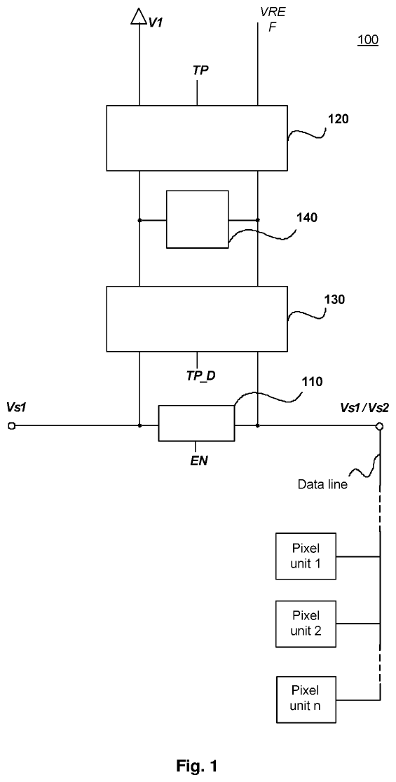

FIG. 1 illustrates a structural block diagram of a source driving enhancement circuit 100 according to an embodiment of the present disclosure. As shown in FIG. 1, the source driving enhancement circuit 100 may comprise a switch sub-circuit 110, a charging sub-circuit 120, an enhancement sub-circuit 130, and an energy storage sub-circuit 140. The source driving enhancement circuit 100 is schematically illustrated in FIG. 1 as having an output connected to a data line and charging corresponding pixel unit 1, pixel unit 2, . . . , pixel unit via the data line.

The switch sub-circuit 110 is electrically connected to a switch control signal line for providing a switch control signal EN, a source driving signal line for providing a source driving signal Vs1, and the data line.

The charging sub-circuit 120 is electrically connected to a charging control signal line for providing a charging control signal TP, a first voltage V1, a charging voltage VREF, and a first terminal and a second terminal of the energy storage sub-circuit 140, to enable charging of the energy storage sub-circuit 140. In one embodiment, the first voltage V1 is shown to be at a relatively low level, for example, a ground potential.

In the present application, it is necessary to enhance a source driving voltage Vs1 using the charging voltage VREF. Therefore, a voltage polarity of VREF may coincide with a voltage polarity of Vs1. When the source driving signal charges the pixel units, Vs1 is a positive voltage, and at this time, VREF is also a positive voltage. Similarly, when the source driving signal reversely charges (i.e., discharges) the pixel units, Vs1 is a negative voltage, and at this time, VREF is also a negative voltage.

The enhancement sub-circuit 130 may be electrically connected to an enhancement control signal line for providing an enhancement control signal TP_D, the source driving signal line, the data line, and the first terminal and the second terminal of the energy storage sub-circuit 140. The energy storage sub-circuit 140 may enable a voltage received by the data line to be an enhanced source driving voltage Vs2 by means of the enhancement sub-circuit 130.

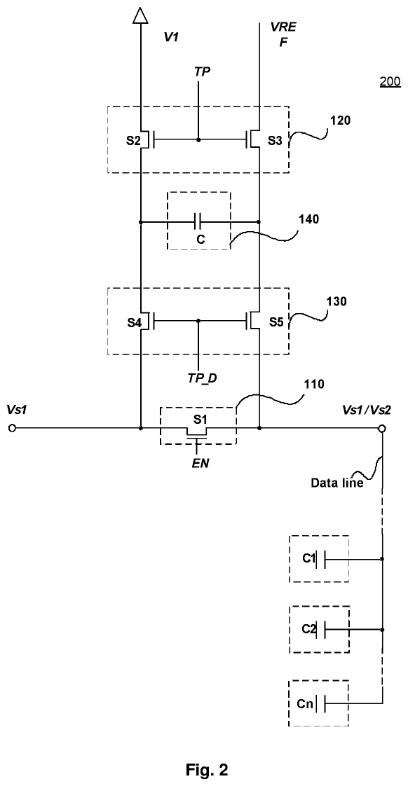

FIG. 2 illustrates a schematic circuit diagram of the source driving enhancement circuit 100 shown in FIG. 1.

As can be seen from FIG. 2, the switch sub-circuit 110 may comprise a first transistor S1. Here, the first transistor S1 has a gate connected to the switch control signal line, a first electrode connected to the source driving signal line, and a second electrode connected to the data line.

The charging sub-circuit 120 comprises a second transistor S2 and a third transistor S3. A gate of the second transistor S2 and a gate of the third transistor S3 are connected to the charging control signal line, to provide the charging control signal TP to the gate of the second transistor S2 and the gate of the third transistor S3 respectively. The second transistor S2 has a first electrode connected to receive the first voltage V1, and a second electrode connected to the first terminal of the energy storage sub-circuit. The third transistor S3 has a first electrode connected to receive the charging voltage VREF, and a second electrode connected to the second terminal of the energy storage sub-circuit.

It should be understood that in an alternative embodiment, the second transistor S2 and the third transistor S3 may be configured to satisfy a condition that the first electrode of the third transistor S3 is connected to receive the first voltage V1, the first electrode of the second transistor S2 is connected to receive the charging voltage VREF, and remaining connection relationships remain unchanged. At this time, it is equivalent to interchanging the charging voltage VREF with the first voltage V1 in FIG. 2. In order to ensure the realization of the enhancement, it is only necessary to change the voltage polarities of VREF and V1 accordingly. Considering that V1 is at a relatively low level (for example, a ground potential), it is only necessary to change the voltage polarity of VREF. For example, if the second transistor S2 is connected to the charging voltage VREF and the third transistor S3 is connected to the first voltage V1, the voltage polarity of the charging voltage VREF should be opposite to the voltage polarity of the source driving signal.

The enhancement sub-circuit 130 may comprise a fourth transistor S4 and a fifth transistor S5. A gate of the fourth transistor S4 and a gate of the fifth transistor S5 are electrically connected to the enhancement control signal line to provide the enhancement control signal TP_D to the gate of the fourth transistor S4 and the gate of the fifth transistor S5 respectively. The fourth transistor S4 may have a first electrode connected to the source driving signal line, and a second electrode connected to the first terminal of the energy storage sub-circuit. The fifth transistor S5 has a first electrode connected to the data line, and a second electrode connected to the second terminal of the energy storage sub-circuit.

The energy storage sub-circuit 140 comprises a capacitor C. The first terminal and the second terminal of the energy storage sub-circuit 140 are a first terminal and a second terminal of the capacitor C respectively.

It should be illustrated that in FIG. 2, for convenience of description, individual pixel units are only simply shown as single pixel capacitors. It can be understood by those skilled in the art that the usage scope of the technical solutions of the present disclosure is not limited thereto. In one embodiment, the pixel capacitors are charged using the output of the source driving enhancement circuit 100.

In response not to enhancing the source driving signal voltage Vs1, the switch sub-circuit 110 is turned on, the charging sub-circuit 120 is turned off, and the enhancement sub-circuit 130 is turned off under control of the switching control signal, the charging control signal, and the enhancement control signal. At this time, the source driving signal voltage Vs1 is directly output to the data line through the switch sub-circuit 110, and the output voltage is the source driving voltage Vs1.

In response to enhancing the source driving signal voltage Vs1, firstly, the switch sub-circuit 110 is turned on, the charging sub-circuit 120 is turned on, and the enhancement sub-circuit 130 is turned off under control of the switching control signal, the charging control signal, and the enhancement control signal, to charge the energy storage sub-circuit 140 with the charging voltage VREF while providing the source driving signal Vs1 to the data line. For example, the second transistor S2 and the third transistor S3 are turned on, and the charging voltage VREF charges the capacitor C.

Then, the switch sub-circuit 110 is turned off, the charging sub-circuit 120 is turned off, and the enhancement sub-circuit 130 is turned on, to provide the enhanced source driving voltage Vs2 to the data line. For example, the first transistor S1, the second transistor S2, and the third transistor S3 are turned off, the fourth transistor S4 and the fifth transistor S4 are turned on, the capacitor C is discharged, and the input source driving voltage Vs1 is enhanced to the enhanced source driving voltage Vs2 through the fourth transistor S4 and the capacitor C, and is applied to the data line through the fifth transistor S5. The enhanced source driving voltage Vs2 has an amplitude equal to a sum of an amplitude of the source driving voltage Vs1 and an amplitude of the charging voltage VREF minus the first voltage V1, i.e., |Vs2|=|Vs1|+|VREF|−V1. Since V1 is close to zero potential, at this time, the driving voltage received by the data line is enhanced by the enhancement sub-circuit, and the voltage output to the data line is the enhanced source driving voltage Vs2.

It can be understood by those skilled in the art that when the source driving signal charges the pixel units, Vs1 is a positive voltage, and at this time, VREF is set to a positive voltage, and thus the voltage Vs2 applied to the input terminal of the fifth transistor S5 is (Vs1+VREF−V1)=|Vs1|+|VREF|−V1. Since V1 is negligible, that is, |Vs2|=|Vs1|+|VREF|, the voltage amplitude of the enhanced source driving voltage Vs2 is increased as compared with the source driving voltage Vs1. When the source driving signal reversely charges (i.e., discharges) the pixel units, Vs1 is a negative voltage, and at this time, VREF is set to a negative voltage, and thus the voltage Vs2 applied to the input terminal of the fifth transistor S5 is (Vs1+VREF−V1)=−(|Vs1|−|VREF|−V1). Since V1 is negligible, that is, |Vs2|=|Vs1|+|VREF|, the voltage amplitude of the enhanced source driving voltage Vs2 is increased as compared with the source driving voltage Vs1.

Further, FIG. 2 only illustrates a schematic circuit diagram of the source driving enhancement circuit 100 according to an embodiment of the present disclosure. It can be understood by those skilled in the art that various variations may be implemented based on the example shown in FIG. 2. For example, the energy storage sub-circuit 140 according to the embodiment of the present disclosure may be implemented using a plurality of capacitors connected in parallel or in series, and thus capacity of the energy storage sub-circuit may be flexibly designed according to an application environment. Further, the switch sub-circuit 110, the charging sub-circuit 120, and/or the enhancement sub-circuit 130 according to the embodiment of the present disclosure may be implemented using other combinations of transistors, which will not be repeated in the description for the sake of brevity.

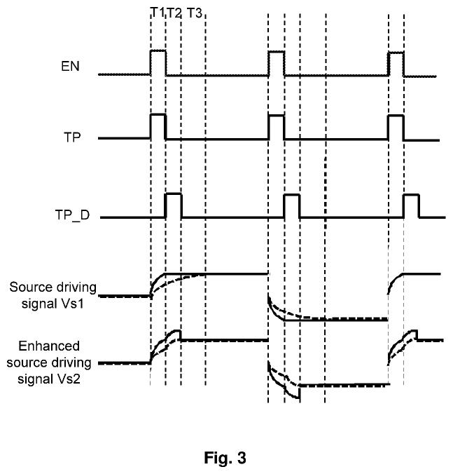

FIG. 3 illustrates an exemplary timing diagram of the circuit shown in FIG. 2. It should be illustrated that amplitudes of various signals in FIG. 3 are merely exemplary and are only used to reflect a variation trend of an amplitude of each of the signals and do not represent specific values. Different signals, even if shown as having the same signal amplitude in the figure, do not imply that they actually have the same amplitude. Similarly, different signals, even if shown as having different signal amplitudes in the figure, do not imply that they actually have different amplitudes.

A timing diagram of the following signals is shown in FIG. 3: a switch control signal EN (wherein only a timing of EN when enhancement is performed is illustrated, and it only needs to keep EN at a low level when no enhancement is performed), a charging control signal TP, an enhancement control signal TP_D, a level applied to the pixel units when no enhancement is performed (a signal corresponding to “unenhanced” in FIG. 3), and a level applied to the pixel units when enhancement is performed (a signal corresponding to “enhanced” in FIG. 3).

Firstly, as described above, if it is determined that the source driving voltage Vs1 is not enhanced, the switch sub-circuit 110 is turned on, the charging sub-circuit 120 is turned off, and the enhancement sub-circuit 130 is turned off under control of the switching control signal, the charging control signal, and the enhancement control signal, so that the voltage output to the data line is the source driving voltage Vs1, at which time the level of the pixel units corresponds to the “unenhanced” signal in FIG. 3. At this time, it only needs to consider this signal in FIG. 3.

A solid line portion of the “unenhanced” signal corresponds to a case where there is no RC delay, and a dotted line portion of the “unenhanced” signal corresponds to a case where there is an RC delay. It can be seen that when there is no RC delay, the pixel units may quickly be charged to a predetermined level (as shown in FIG. 3, after time T1). When the RC delay occurs, this charging time period is greatly prolonged. This may cause an undercharging condition to occur. Thereby it needs to consider the enhancement of the source driving voltage.

As described above, if it is determined that the source driving voltage Vs1 is enhanced, the process proceeds to an enhancement operation process including a charging phase (a first phase) and an enhancement phase (a second phase).

Under control of the switch control signal, the charging control signal and the enhancement control signal, the switch sub-circuit 110 is turned on, the charging sub-circuit 120 is turned on, and the enhancement sub-circuit 130 is turned off during the charging period, so that the charging sub-circuit 120 charges the energy storage sub-circuit 140. At this time, a charging rate of the pixel units is the same as that in the “unenhanced” case (as indicated by the dotted line portions (or the solid line portions) of the “unenhanced” signal and the “enhanced” signal in the T1 segment in FIG. 3). In the enhancement phase, the switch sub-circuit 110 is turned off, the charging sub-circuit 120 is turned off, and the enhancement sub-circuit 130 is turned on, so that the enhancement sub-circuit 130 applies a potential of the energy storage sub-circuit 140 to the source driving voltage Vs1 to charge the pixel units, i.e., charging the pixel units using the enhanced source driving voltage Vs2.

The solid line portion of the “enhanced” signal corresponds to the case where there is no RC delay, and the dotted line portion corresponds of the “enhanced” signal corresponds to the case where there is an RC delay. It can be seen that after the enhancement is performed, when there is an RC delay, the charging time is shortened from the original T1+T2+T3 to T1+T2. This improves the effect of the RC delay and suppresses the occurrence of undercharging conditions.

As shown in FIG. 3, in a next cycle, a similar effect may also be achieved for the case of reverse charging, except that as described above, it is necessary to change the voltage polarity of VREF as compared with the case of positive charging (considering that V1 is at a low level (for example, a ground potential), it may select to change or not to change the voltage polarity of V1).

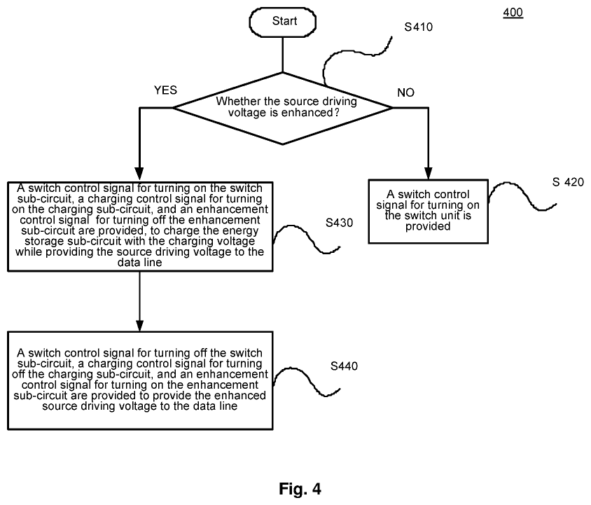

FIG. 4 illustrates a flowchart of a source driving enhancement method 400 according to an embodiment of the present disclosure.

The source driving enhancement method 400 starts at step S410, in which it is determined whether the source driving voltage Vs1 is enhanced.

If “NO”, in step S420, a switch control signal for turning on the switch sub-circuit 110 is provided to provide the source driving voltage Vs1 to the data line.

If “YES”, then in step S430, a first phase starts. Here, the switch control signal line provides a switch control signal EN for turning on the switch sub-circuit 110, the charging control signal line provides a charging control signal TP for turning on the charging sub-circuit 120, and the enhancement control signal line provides an enhancement control signal TP_D for turning off the enhancement sub-circuit 130, to charge the energy storage sub-circuit 140 with the charging voltage VREF while providing the source driving voltage Vs1 to the data line.

Then, in step S440, the process proceeds to a second phase. Here, a switch control signal EN for turning off the switch sub-circuit 110, a charging control signal TP for turning off the charging sub-circuit 120, and an enhancement control signal TP_D for turning on the enhancement sub-circuit 130 are provided to provide the enhanced source driving voltage Vs2 to the data line, wherein the enhanced source driving voltage Vs2 has an amplitude equal to a sum of an amplitude of the source driving voltage Vs1 and an amplitude of the charging voltage minus the first voltage.

The present disclosure further proposes a source driving circuit. The source driving circuit comprises the source driving enhancement circuit 100 as shown in FIGS. 1 and/or 2.

The present disclosure further proposes a display device. The display device comprises a switch control signal line; a source driving signal line; a data line; and the source driving circuit as described above.

The detailed description above has set forth numerous embodiments by using schematic diagrams, flowcharts and/or examples. In a case where such schematic diagrams, flowcharts, and/or examples comprise one or more functions and/or operations, it should be understood by those skilled in the art that each of the functions and/or operations in such schematic diagrams, flowcharts, or examples may be implemented individually and/or collectively by various structures, hardware, software, firmware or substantially any combination thereof.

Although the present disclosure has been described with reference to a few exemplary embodiments, it is understood that the terms used are illustrative and exemplary and not restrictive. The present disclosure may be embodied in a variety of forms without departing from the spirit or substance of the present disclosure. Therefore, it is to be understood that the embodiments described above are not limited to any detail described above, but are construed broadly within the spirit and scope defined by the appended claims. Accordingly, all changes and modifications which fall within the scope of the claims or the equivalents thereof are intended to be covered by the appended claims.

1. A source driving enhancement circuit, comprising:
a switch sub-circuit electrically connected to a switch control signal line, a source driving signal line, and a data line;
an energy storage sub-circuit having a first terminal and a second terminal;
a charging sub-circuit electrically connected to a charging control signal line, and the first terminal and the second terminal of the energy storage sub-circuit, and configured to receive a first voltage, a charging voltage, and a charging control signal from the charging control signal line, and charge the energy storage sub-circuit using the first voltage and the charging voltage under control of the charging control signal; and
an enhancement sub-circuit electrically connected to an enhancement control signal line, the source driving signal line, the data line, and the first terminal and the second terminal of the energy storage sub-circuit, and configured to receive an enhancement control signal from the enhancement control signal line, and provide an enhanced source driving signal to the data line under control of the enhancement control signal.

2. The source driving enhancement circuit according to claim 1, wherein the switch sub-circuit comprises a first transistor, wherein the first transistor has a gate connected to the charging control signal line, a first electrode connected to the source driving signal line, and a second electrode connected to the data line.

3. The source driving enhancement circuit according to claim 1, wherein the charging sub-circuit comprises a second transistor and a third transistor, wherein a gate of the second transistor and a gate of the third transistor are connected to the charging control signal line, the second transistor has a first electrode connected to receive the first voltage, and a second electrode connected to the first terminal of the energy storage sub-circuit, and the third transistor has a first electrode connected to receive the charging voltage, and a second electrode connected to the second terminal of the energy storage sub-circuit.

4. The source driving enhancement circuit according to claim 1, wherein the enhancement sub-circuit comprises a fourth transistor and a fifth transistor, wherein a gate of the fourth transistor and a gate of the fifth transistor are connected to the enhancement control signal line, the fourth transistor has a first electrode connected to the source driving signal line and a second electrode connected to the first terminal of the energy storage sub-circuit, and the fifth transistor has a first electrode connected to the data line, and a second electrode connected to the second terminal of the energy storage sub-circuit.

5. The source driving enhancement circuit according to claim 1, wherein the energy storage sub-circuit comprises a capacitor, wherein the first terminal and the second terminal of the energy storage sub-circuit are a first terminal and a second terminal of the capacitor respectively.

6. The source driving enhancement circuit according to claim 1, wherein in response not to enhancing the source driving signal, the switch sub-circuit is turned on, the charging sub-circuit is turned off, and the enhancement sub-circuit is turned off under control of the switch control signal, the charging control signal, and the enhancement control signal on the enhancement control signal.

7. The source driving enhancement circuit according to claim 1, wherein in response to enhancing the source driving, under control of the switch control signal, the charging control signal, and the enhancement control signal,
the switch sub-circuit is turned on, the charging sub-circuit is turned on, and the enhancement sub-circuit is turned off, to charge the energy storage sub-circuit with the charging voltage while providing a source driving voltage to the data line, and
the switch sub-circuit is turned off, the charging sub-circuit is turned off, and the enhancement sub-circuit is turned on, to provide an enhanced source driving voltage to the data line, wherein the enhanced source driving voltage has an amplitude equal to a sum of an amplitude of the source driving voltage and an amplitude of the charging voltage minus the first voltage.

8. A source driving enhancement method using the source driving enhancement circuit according to claim 1, comprising:
determining whether the source driving is enhanced;
when it is determined that the source driving signal is not enhanced, providing, on the switch control signal line, a switch control signal for turning on the switch sub-circuit to provide a source driving voltage to the data line, and
when it is determined that the source driving signal is enhanced,
during a first period, providing, on the switch control signal line, a switch control signal for turning on the switch sub-circuit, providing, on the charging control signal line, a charging control signal for turning on the charging sub-circuit, and providing, on the enhancement control signal line, an enhancement control signal for turning off the enhancement sub-circuit, to charge the energy storage sub-circuit with the charging voltage while providing the source driving voltage to the data line; and
during a second period, providing, on the switch control signal line, a switch control signal for turning off the switch sub-circuit, providing, on the charging control signal line, a charging control signal for turning off the charging sub-circuit, and providing, on the enhancement control signal line, an enhancement control signal for turning on the enhancement sub-circuit, to provide an enhanced source driving voltage to the data line, wherein the enhanced source driving voltage has an amplitude equal to a sum of an amplitude of the source driving voltage and an amplitude of the charging voltage minus the first voltage.

9. A source driving circuit comprising the source driving enhancement circuit according to claim 1.

10. A display device comprising:
a switch control signal line;
a source driving signal line;
a data line; and
the source driving circuit according to claim 9.
